(19) United States
(12) Patent Application Publication
(10) Pub. No.: US 2024/0257174 A1
(43) Pub. Date: Aug. 1, 2024

(54) METHOD FOR SELECTING CONTENTS CREATOR BASED ON E-COMMERCE AND COMPUTING DEVICE FOR EXECUTING THE SAME

(71) Applicant: CONIALAB CO., LTD., Seoul (KR)

(72) Inventor: HYUN JUNG NA, Gyeonggi-do (KR)

(21) Appl. No.: 18/422,282

(22) Filed: Jan. 25, 2024

(30) Foreign Application Priority Data
Jan. 26, 2023 (KR) 10-2023-0010447

(51) Int. Cl. G06Q 30/0242; G06Q 30/0251

(52) U.S. Cl. CPC G06Q 30/0242; G06Q 30/0254

(57) ABSTRACT

A method for providing information based on e-commerce according to an embodiment of the present disclosure is performed on a computing device including one or more processors and a memory that stores one or more programs executed by the one or more processors, and includes receiving a product promotion request including product information and requester identification information for a product to be promoted, and selecting a contents creator to create promotional content for the product in response to the product promotion request.

### CROSS REFERENCE TO RELATED APPLICATIONS AND CLAIM OF PRIORITY

This application claims the benefit under 35 USC § 119 of Korean Patent Application No. 10-2023-0010447 filed on Jan. 26, 2023 in the Korean Intellectual Property Office, the entire disclosure of which is incorporated herein by reference for all purposes.

### BACKGROUND

### 1. Field

Embodiments of the present disclosure relate to a technology for selecting a contents creator based on e-commerce.

### 2. Description of Related Art

With the development of information and communication technology, online commerce, that is, e-commerce, which involves selling a product by building an online market, has developed. The initial form of online commerce was in the form in which a seller opened an online shopping mall (hereinafter referred to as shopping mall) directly, registered the product, and a visitor who accessed the shopping mall purchased the product, but with the advent of intermediary shopping malls that connect a seller and a purchaser emerged and grew into a large shopping malls (e.g., Auction, 11th Street, G Market, etc.) by providing convenient sales and purchasing services, which leads to explosive growth in an e-commerce market. Since then, this explosive growth has continued with the emergence of social commerce using social networks (e.g., Tmon, Wemakeprice) and various forms of e-commerce (e.g., Coupang) that provide innovative offline distribution and logistics services. These large-scale e-commerce platforms (e.g., large intermediary platforms, social commerce, etc.) are bringing large profits to a user, especially the seller.

Recently, a new type of e-commerce market is being actively formed using communication channels with fans of highly influential individuals with great influence on social network services (SNS) (e.g., Facebook, Instagram) and individual media services (e.g., influencer, celebrity, etc.), or through strong personal networks in communities where people with similar personal interests gather.

### SUMMARY

Embodiments of the present disclosure are intended to provide a new method for selecting a contents creator based on e-commerce and a computing device for executing the same.

According to an exemplary embodiment of the present disclosure, there is provided a method for selecting a contents creator based on e-commerce performed on a computing device including one or more processors and a memory that stores one or more programs executed by the one or more processors, the method including receiving a product promotion request including product information for a product to be promoted and requester identification information, selecting a contents creator to create promotional content for the product in response to the product promotion request, the selecting of the contents creator includes extracting contents including a product related to the product from among contents registered on a platform in an e-commerce environment, displaying sales-related information including sales information and sales forecast information for a product included in the extracted content, and displaying information on the contents creator who created the extracted content (including information on a first contents creator who is a model for the corresponding product and a second contents creator who created the content and is an expert in each field of the content), the displaying of the information on the contents creator further includes displaying a button for contacting the contents creator, the button is linked to an email address of the contents creator or is linked to a mobile phone of the contents creator, the right of access to the sales-related information is restricted so that the sales-related information is displayed only to a seller or supplier of the corresponding product, and, in the displaying of the sales-related information, when the seller or supplier clicks on a predetermined product in the content registered on the platform, the sales-related information of the clicked product is displayed on a screen.

The selecting of the contents creator may include extracting a first promotional candidate group based on the product information from among first contents creators who have registered content on the platform in the e-commerce environment, calculating a first promotional suitability level for the product for the first contents creators extracted as the first promotional candidate group, and finally selecting a first contents creator who serves as a model for product promotion from among the extracted first contents creators according to the calculated first promotional suitability level.

The extracting of the first promotional candidate group may include calculating a degree of similarity between the product included in the product promotion request and the product included in the already registered contents, and when the calculated similarity is greater than or equal to a preset threshold value, extracting the first contents creator who registered the corresponding content as the first promotional candidate group.

In the calculating of the first promotional suitability level, based on suitability level determination factors including one or more of the number of times or frequency of uploads of content related to the product, a degree of social feedback of content related to the product, a degree of influence of the extracted first contents creator, and forecasted sales related to the product of the extracted first contents creator, the first promotional suitability level is calculated for each of the extracted first contents creators.

The calculating of the first promotional suitability level may include assigning a first-first suitability level score to each of the extracted first contents creators according to one or more of the number of times and frequency of uploads of content related to the product, assigning a first-second suitability level score to each of the extracted first contents creators according to the degree of social feedback of content related to the product, assigning a first-third suitability level score according to the influence of each of the extracted first contents creators, assigning a first-fourth suitability level score according to forecasted sales related to the product of the extracted first contents creators, and calculating the first promotional suitability level for each of the extracted first contents creators by adding up the first-first suitability level score, the first-second suitability level score, the first-third suitability level score, and the first-fourth suitability level score.

In the finally selecting of the first contents creator, the first contents creator with the highest first promotional suitability level among the extracted first contents creators may be finally selected as the first contents creator who serves as a model for the product promotion.

The method for selecting the contents creator based on e-commerce may further includes selecting a second contents creator to create promotional content for the product together with the first contents creator finally selected as a model for the product promotion in each field.

The selecting of the second contents creator in each field may include extracting second contents creators who have collaborated with the finally selected first contents creator as a second promotional candidate group in each field, calculating a second promotional suitability level related to creation of the promotional content for each of the second contents creators extracted as the second promotional candidate group, and finally selecting a second contents creator in each field from among the extracted second contents creators according to the calculated second promotional suitability level.

In the calculating of the second promotional suitability level, the second promotional suitability level may be calculated for each of the extracted second contents creators based on suitability level determination factors including one or more of the number of times of collaborations with the finally selected first contents creator, the collaboration satisfaction level of the finally selected first contents creator, and the number of times of content creations related to the product.

The calculating of the second promotional suitability level may include assigning a second-first suitability level score to each of the extracted second contents creators according to the number of times of collaborations with the finally selected first contents creator, assigning a second-second suitability level score to each of the extracted second contents creators according to the collaboration satisfaction level of the finally selected first contents creator, assigning a second-third suitability level score to each of the extracted second contents creators according to the number of times of content creations related to the product, and calculating the second promotional suitability level by adding up the second-first suitability level score, the second-second suitability level score, and the second-third suitability level score of each of the second contents creators in each field.

In the finally selecting of the second contents creator, the second contents creator with the highest second promotional suitability level among the extracted second contents creators may be finally selected as the second contents creator to create the promotional content.

The method for selecting the contents creator may further include transmitting information on the finally selected first contents creator and the finally selected second contents creator in each field in response to the product promotion request.

According to another exemplary embodiment of the present disclosure, there is provided a computing device including one or more processors, a memory, and one or more programs, in which the one or more programs are stored in the memory and configured to be executed by the one or more processors, and the one or more programs include an instruction for receiving a product promotion request including product information for a product to be promoted and requester identification information, an instruction for selecting a contents creator to create promotional content for the product in response to the product promotion request, the instruction for the selecting of the contents creator includes an instruction for extracting contents including a product related to the product from among contents registered on a platform in an e-commerce environment, an instruction for displaying sales-related information including sales information and sales forecast information for a product included in the extracted content, and an instruction for displaying information on the contents creator who created the extracted content (including information on a first contents creator who is a model for the corresponding product and a second contents creator who created the content and is an expert in each field of the content, the instruction for displaying of the information on the contents creator further includes displaying a button for contacting the contents creator, the button is linked to an email address of the contents creator or is linked to a mobile phone of the contents creator, the right of access to the sales-related information is restricted so that the sales-related information is displayed only to a seller or supplier of the corresponding product, and in the instruction for displaying of the sales-related information, when the seller or supplier clicks on a predetermined product in the content registered on the platform, the sales-related information of the clicked product is displayed on the screen.

### BRIEF DESCRIPTION OF THE DRAWINGS

FIG. 1 is a diagram illustrating an e-commerce environment according to an embodiment of the present disclosure.

FIG. 2 is a diagram illustrating a state in which a contents creator registers content on a platform in the e-commerce environment according to an embodiment of the disclosure.

FIG. 3 is a flowchart illustrating a process of recommending a contents creator by the platform server according to a product promotion request in an embodiment of the present disclosure.

FIG. 4 is a diagram illustrating a state in which contents creator information is displayed on content uploaded to the platform according to an embodiment of the present disclosure.

FIG. 5 is a diagram illustrating a state in which sales-related information of products included in content is displayed in an embodiment of the present disclosure.

FIG. 6 is a block diagram for illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In the following description, “transfer,” “communication,” “transmission,” “reception,” of a signal or information and other terms having similar meaning include not only direct transmission of a signal or information from one component to another component, but also transmission of the signal or information through another component. In particular, “transferring” or “transmitting” a signal or information to a component indicates a final destination of the signal or information and does not mean a direct destination. This is the same for “receiving” a signal or information. In addition, in this specification, the fact that two or more pieces of data or information are “related” means that if one data (or information) is acquired, at least part of the other data (or information) can be obtained based on it.

Additionally, terms such as first, second, etc. may be used to describe various components, but the components should not be limited by the terms. Terms may be used for the purpose of distinguishing one component from another. For example, a first component may be referred to as a second component, and similarly, the second component may also be referred to as a first component without departing from the scope of the present disclosure.

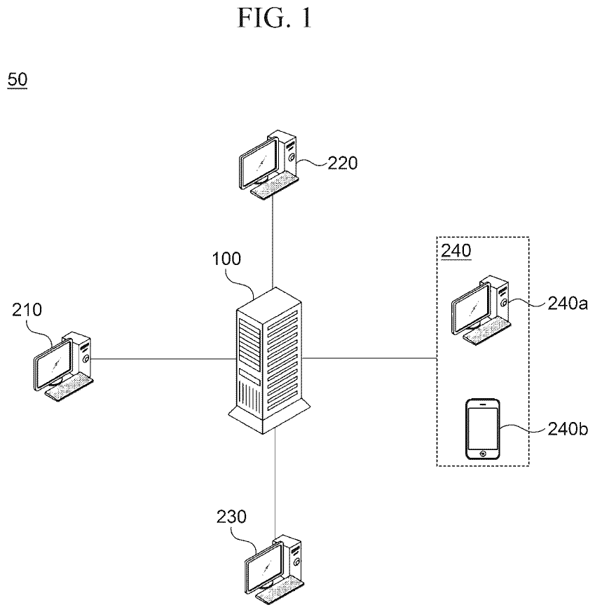

FIG. 1 is a diagram illustrating an e-commerce environment according to an embodiment of the present disclosure.

Referring to FIG. 1, the e-commerce environment 50 may include a platform server 100, a supplier terminal 210, a seller terminal 220, a contents creator terminal 230, and a purchaser terminal 240. The platform server 100 may be connected to each of the supplier terminal 210, the seller terminal 220, the contents creator terminal 230, and the purchaser terminal 240 through a communication network.

The platform server 100 may provide e-commerce platform services through user terminals 210, 220, 230, and 240. The e-commerce platform services may include overall services required to sell products online, such as product supply, sales, promotion, and purchase.

According to one embodiment, the platform server 100 may register a supplier of a product to be sold on the platform through the supplier terminal 210. The supplier may be, for example, a person who supplies the product to be sold on the platform and delivers the product sold by a seller. In other words, the supplier may be a person who is only responsible for product distribution and entrusts the rest to other users.

According to one embodiment, the platform server 100 may register the product supplied by the supplier through the supplier terminal 210. The platform server 100 may provide a service for managing product registration through the provider terminal 210. According to one embodiment, the platform server 100 may provide a list of registered products. According to one embodiment, the platform server 100 may update the list of registered products. For example, the platform server 100 may receive application information for registering a new product from the supplier, and add the product to the list if registration is approved. Additionally, the platform server 100 may receive request information for deleting a registered product from the supplier and delete the requested product from the list.

According to one embodiment, the platform server 100 may provide a service for managing product sales through the supplier terminal 210. According to one embodiment, the platform server 100 may provide sales information of the registered product. The sales information may include, for example, information such as sales volume, order amount, and deposit amount. According to one embodiment, the platform server 100 may provide a service for managing product inventory. For example, the inventory management service may be managed together with product registration.

According to one embodiment, the platform server 100 may provide settlement information for a sold product. The settlement information may include, for example, information about sales, settlement, and deposit. According to one embodiment, when receiving a settlement request from the supplier, the platform server 100 may process a process for paying a settlement amount.

According to one embodiment, the platform server 100 may provide a service necessary for product sales to the seller through the seller terminal 220. According to one embodiment, the platform server 100 may register the seller through the seller terminal 220. The seller may be, for example, a person who sells the product registered on the platform by the supplier. According to one embodiment, the platform server 100 may register a product available for sale of the seller through the seller terminal 220.

According to one embodiment, the platform server 100 may provide a comprehensive solution for selling the product through the seller terminal 220. According to one embodiment, the platform server 180 may provide a solution for creating an online shopping mall within the platform. For example, the platform server 180 may provide a function capable of creating an online shopping mall using a drag and drop method through a GUI without hard coding. Additionally, the platform server 180 may provide a premade design template.

According to one embodiment, the platform server 100 may register a product for sale of the seller in the online shopping mall. For example, the product for sale may be a product approved for sale to the seller. According to one embodiment, the platform server 100 may create an online shopping mall requested by the seller. For example, the platform server 100 may create the online shopping mall created by each seller. Each seller can create a separate online shopping mall according to his or her tastes. Accordingly, the purchaser may selectively subscribe to an online shopping mall that suits his or her tastes on the platform service, becomes a member, and purchase a registered product.

According to one embodiment, the platform server 100 may provide a service for managing the online shopping mall through the seller terminal 220. For example, the platform server 100 may provide a solution for setting the name, URL, logo, banner, etc. of the online shopping mall.

According to one embodiment, the platform server 100 may provide a list of products available for sale. According to one embodiment, the platform server 100 may update the list of products available for sale. For example, the platform server 100 may receive an approval application for selling a new product from the seller, and add the new product to the list when the sale is approved. According to one embodiment, the platform server 100 may receive profit rate setting information for the sold product from the seller.

According to one embodiment, the platform server 100 may provide sales information of the product sold in the online shopping mall to the seller terminal 220. The sales information may include, for example, information similar to information provided to the supplier, such as sales volume, order amount, deposit amount, etc., as well as member information of the purchaser. The platform server 100 may provide services for managing orders, delivery, and refunds to the seller terminal 220.

According to one embodiment, the platform server 100 may provide a service necessary for content provision to the supplier through the contents creator terminal 230.

According to one embodiment, the platform server 100 may register a contents creator. For example, the contents creator may create content that helps sell a product and provide the created content to the supplier and the seller. According to one embodiment, the contents creator may be an expert who is directly or indirectly required to create content. The professional personnel may include, for example, a model, a hair and makeup expert, a stylist, a photographer, an editor, etc. Additionally, the model may be an influencer, a celebrity, etc. on online social media.

According to one embodiment, the platform server 100 may provide a service that allows content created by the contents creator to be shared with platform users. For example, the platform server 100 may provide a content sharing service that uses the platform users as social networks, that is, social network service (SNS). Accordingly, the contents creator can upload the created content to a virtual space where he or she can be identified and share the content with the platform users.

According to one embodiment, the content shared through the content sharing service of the platform server 100 may be content for promoting the product sold on the platform. For example, the content may include information (e.g., URL) about the online shopping mall within the platform where the product being promoted is sold. Accordingly, the purchaser can move to a designated shopping mall using the information and purchase the product. According to one embodiment, the platform server 100 may provide information about participants (e.g., the model, the hair and makeup expert, the stylist, the photographer, etc.) who participated in creating the content together with the content. Accordingly, the supplier and the purchaser can easily check not only the model but also all parties concerned necessary for content creation.

According to one embodiment, the platform server 100 may provide the service necessary for product purchase to the supplier through the purchaser terminal 240.

According to one embodiment, the platform server 100 may register the purchaser as a member in the online shopping mall of the seller. For example, the platform server 100 may register the purchaser as a member in the online shopping mall of each seller.

According to one embodiment, the platform server 100 may receive order information of the purchaser who purchased a product through the online shopping mall. The order information may include, for example, the product and delivery information. According to one embodiment, the platform server 100 may provide a payment service to the purchaser who purchases the product. According to one embodiment, the platform server 100 may transmit the order information to the supplier and the seller when payment is completed. Accordingly, the supplier can deliver the ordered product to the purchaser.

According to one embodiment, the platform server 100 may provide a service for managing an order status through the purchaser terminal 240. According to one embodiment, the platform server 100 may provide the order and delivery information for the product purchased from the online shopping mall. According to one embodiment, when receiving order correction information, the platform server 100 may modify the order information based on the received correction information.

According to one embodiment, the platform server 100 may include a database (DB) for data storage, as well as a computing module necessary to provide the e-commerce platform service. In other words, the platform server 100 may include a server configuration generally required to provide the e-commerce service. According to one embodiment, the platform server 100 may provide useful information to a service user by analyzing information stored in the database. The useful information may include, for example, basic data useful for product supply, product sales, content creation, and product purchase and processed data.

According to one embodiment, the user terminals 210, 220, 230, and 240 may be general-purpose devices such as a desktop personal computer (PC), a laptop PC (notebook PC), a smartphone, a tablet PC, a personal digital assistant (PDA), etc. For example, the supplier terminal 210, the seller terminal 220, and the user terminal 230 may be electronic devices with relatively low portability, such as the desktop PC and the laptop PC. The purchaser terminal 240 may be a smartphone 240b as well as a desktop PC 240a with low portability.

The e-commerce environment 50 described above can provide the e-commerce platform service in which the suppliers who supply products, the sellers who create the online shopping mall to sell the products, and creators who create content to promote the products coexist on one platform, and which sells products to the purchasers, and shares profits from product sales.

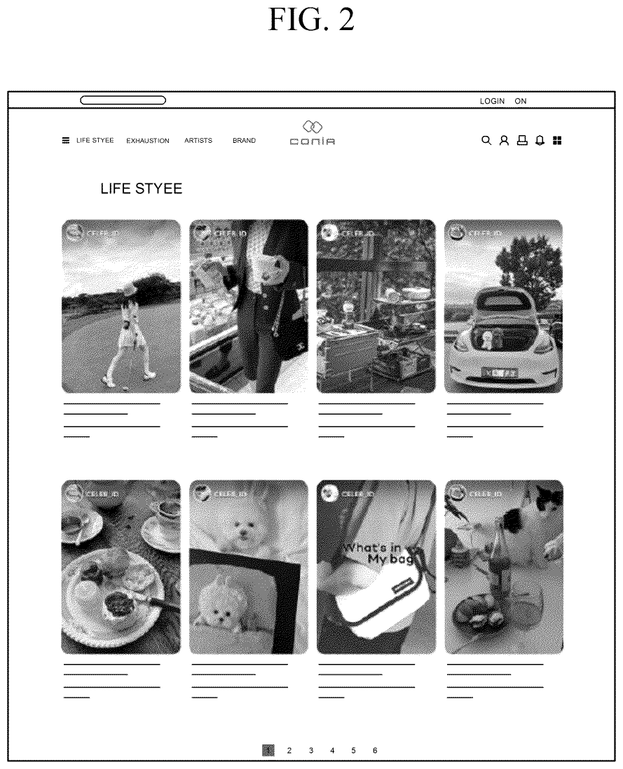

FIG. 2 is a diagram illustrating a state in which the contents creator registers content on the platform in the e-commerce environment according to an embodiment of the disclosure.

Referring to FIG. 2, the contents creator may register photos or video images containing certain products (e.g., golf equipment, food, dolls, bags, camping gear, etc.) on the platform. The contents creators may upload content containing the product using social network services provided on the platform. For example, the contents creator may photograph the product he or she purchases or use in his or her daily lives and upload the product to the platform, but is not limited thereto.

Here, the platform server 100 may provide a service for connecting the supplier or seller with the contents creator. According to one embodiment, the platform server 100 may connect the supplier or seller who wishes to request the production of content for product promotion to the contents creator.

In this case, the contents creators may be divided into a model (i.e., the influencer or the celebrity, etc.) of the content for promoting the product and an expert involved in creating content (e.g., a makeup expert, a stylist, a photographer, an editor, etc.). Hereinafter, the model may be referred to as a first contents creator, and the expert in each field may be referred to as a second contents creator. When a product promotion request is received from the supplier or seller, the platform server 100 may recommend the model (first contents creator) for promoting the product and the expert (second contents creator).

According to one embodiment, the platform server 100 may connect the supplier or seller who wants to sponsor the product to the contents creator. For example, the platform server 100 may provide the contents creator with a sponsored product that the supplier or seller wishes to provide. According to one embodiment, the platform server 100 may connect a contents creator who is expected to have high promotional effects to the supplier and the seller. For example, the platform server 100 may connect the contents creator who is expected to have a high promotional effect based on previously created content, sales of the product of the created content, etc.

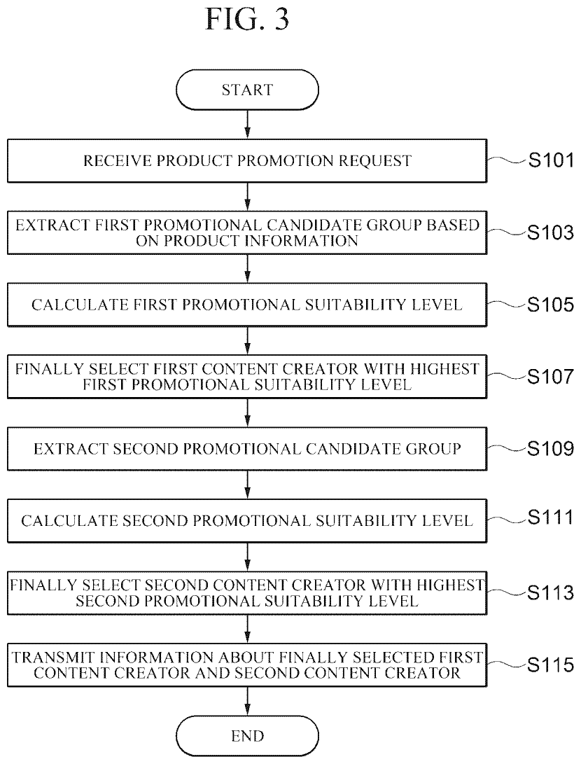

FIG. 3 is a flowchart for illustrating a process of recommending the contents creator by the platform server 100 according to the product promotion request in one embodiment of the present disclosure. In the illustrated flowchart, the method is described by being divided into a plurality of steps, but at least some of the steps may be performed in a different order, may be performed together in combination with other steps, omitted, may be performed by being divided into detailed steps, or may be performed by being added with one or more steps (not illustrated).

Referring to FIG. 3, the platform server 100 may receive the product promotion request (S 101). Here, the product promotion request may be received from one or more of the supplier terminal 210 and the seller terminal 220. The product promotion request may include identification information of the requester requesting product promotion (requester identification information) and product information about the product to be promoted.

Next, the platform server 100 may extract the first contents creators related to the corresponding product (i.e., models such as influencers or celebrities) as the first promotional candidate group based on the product information included in the product promotion request (S 103).

Specifically, the platform server 100 may extract the first contents creators who registered the content containing a product related to the product included in the product promotion request among the first contents creators who registered content on the platform as the first promotional candidate group.

According to one embodiment, the platform server 100 may calculate a degree of similarity between the product included in the product promotion request and the product included in the already registered content. If the calculated similarity is greater than or equal to a preset threshold value, the platform server 100 may extract the first contents creator who registered the corresponding content as the first promotional candidate group.

For example, if the product included in the product promotion request is golf clothing, the first contents creator who uploaded content containing golf-related products such as golf clothing, golf clubs, golf shoes, golf balls, etc. among the contents registered on the platform may be extracted as the first promotional candidate group.

Next, the platform server 100 may calculate the first promotional suitability level for the corresponding product for the first contents creators extracted as the first promotional candidate group (S 105). In this case, the platform server 100 may calculate the first promotional suitability level for each of the first contents creators extracted as the first promotional candidate group (hereinafter referred to as a candidate first contents creator) based on one or more preset suitability determination factors.

Here, the suitability level determination factors may include one or more of 1) the number of times or frequency of uploads of content related to the corresponding product, 2) a degree of social feedback of content related to the corresponding product, 3) a degree of influence of the candidate first content candidate creator, and 4) forecasted sales related to the corresponding product of the candidate first contents creator, etc.

The platform server 100 may assign a first-first suitability level score to each of the candidate first contents creators according to the number of times or frequency of uploads of content related to the corresponding product. For example, if the product included in the product promotion request is golf clothing, the first-first suitability level score may be assigned depending on how often or how many times in total the candidate first contents creators have uploaded content containing golf-related products.

The platform server 100 may assign a first-second suitability level score to each of the candidate first contents creators according to the degree of social feedback of the content related to the corresponding product. That is, the first-second suitability level score may be assigned depending on how good feedback (e.g., likes, hearts, etc.) is received from users of the platform regarding the content related to the corresponding product.

The platform server 100 may assign a first-third suitability level suitability level score according to the degree of influence of the candidate first contents creator. In this case, the influence of the candidate first contents creator may be determined in consideration of the number of followers of the candidate first contents creator, the total number of uploaded content, the total number of social feedback on the uploaded content, etc.

The platform server 100 may assign a first-fourth suitability level score according to the forecasted sales related to the corresponding product of the candidate first contents creator. Here, the forecasted sales related to the corresponding product of the candidate first contents creator may be calculated based on the average sales of products contained in the contents already registered by the candidate first contents creator.

The platform server 100 may calculate the first promotional suitability level for the corresponding product by adding up the first-first suitability level score, the first-second suitability level score, the first-third suitability level score, and the first-fourth suitability level score of each of the candidate first contents creators. In this case, the platform server 100 may calculate the first promotional suitability level for the corresponding product of each of the first contents creators by assigning weights to the first-first suitability level score, the first-second suitability level score, the first-third suitability level score, and the first-fourth suitability level score, respectively, and then summing the first-first to first-fourth suitability level scores. The sum of the respective weights may be 1.

Next, the platform server 100 may finally select the first contents creator with the highest first promotional suitability level for the corresponding product among the candidate first contents creators as the first contents creator to promote the corresponding product (S 107). That is, the finally selected first contents creator is selected as the model to promote the corresponding product.

Next, the platform server 100 may extract second contents creators in each field who have collaborated with the finally selected first contents creator as a second promotional candidate group (S 109).

That is, the platform server 100 may select second contents creators to create content (promotional content) for promoting the corresponding product from among experts who created content in collaboration with the finally selected first contents creator. In this case, the platform server 100 may extract the second contents creators in each field (e.g., the makeup expert, the stylist, the photographer, the editor, etc.) who have collaborated with the finally selected first contents creator as the second promotional candidate group.

Next, the platform server 100 may calculate a second promotional suitability level related to content creation for each of the extracted second contents creators in each field extracted as the second promotional candidate group (S 111).

In this case, the platform server 100 may calculate the second promotional suitability level of each of the second contents creators in each field (hereinafter may be referred to as candidate second contents creators) extracted as the second promotional candidate group based on one or more preset suitability level determination factors.

Here, the suitability level determination factors may include 1) the number of times of collaborations with the finally selected first contents creator, 2) a collaboration satisfaction level with the finally selected first contents creator, and 3) the number of times of content creations related to the corresponding product.

The platform server 100 may assign a second-first suitability level score to each of the candidate second contents creators in each field according to the number of times of collaborations with the finally selected first contents creator. The platform server 100 may assign a second-second suitability level score to each of the candidate second contents creators in each field according to the collaboration satisfaction level of the finally selected first contents creator. The platform server 100 may assign a second-third suitability level score to each of the candidate second contents creators in each field according to the number of times of content creations related to the corresponding product.

The platform server 100 may calculate the second promotional suitability level by adding up the second-first suitability level score, the second-second suitability level score, and the second-third suitability level score of each of the candidate second contents creators in each field. In this case, the platform server 100 may assign weights to the second-first suitability level score, the second-second suitability level score, and the second-third suitability level score, respectively, and then adds the second-first to second-third suitability level scores to calculate the second promotional suitability level for each of the candidate second contents creators in each field. The sum of the respective weights may be 1.

Next, the platform server 100 may finally select the second contents creator with the highest second promotional suitability level among the second contents creators in each field as the second contents creator to create the promotional content (S 113).

Next, the platform server 100 may transmit information about the finally selected first contents creator and the finally selected second contents creator in each field in response to the product promotion request (S 115).

According to the embodiments of the present disclosure, the first contents creator and the second contents creator related to the product can be collectively recommended in response to the product promotion request, thereby making it possible to create promotional content quickly, show high level of completion, and increase promotional effectiveness.

In addition, the platform server 100 may provide contract information related to the matters described above when creating content with the finally selected first contents creator and second contents creator. The contract information may include, for example, not only information about a contract that has been accepted, progressed, and completed, but also information about the content creation request and product sponsorship proposal. According to one embodiment, the platform server 100 may proceed with a process for the contract when the contents creator accepts the creation request and sponsorship proposal. Meanwhile, here, it has been described that the platform server 100 recommends the contents creators according to the product promotion requests, but is not limited thereto, and the supplier or the seller may directly select contents creators on the platform and connect with the contents creators.

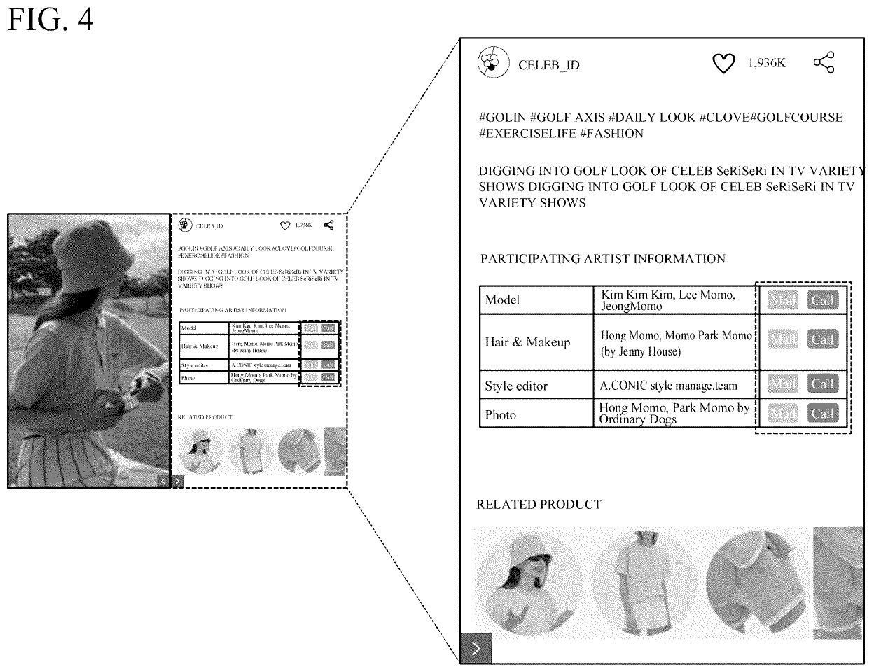

FIG. 4 is a diagram illustrating a state in which contents creator information is displayed on the content uploaded to the platform according to an embodiment of the present disclosure. Referring to FIG. 4, information of the contents creators who participated in the creation of the corresponding content (Model, Hair & Makeup, Style editor, Photo) is displayed in the content.

And, in a region where the contents creator information is displayed, a button to contact each contents creator may be displayed. The button may be linked to an email address of the corresponding contents creator or may be linked to a mobile phone of the corresponding contents creator. Through this, the supplier and the seller who wish to request the creation of promotional content for a product may search for the content related to their product on the platform and then attempt to contact the contents creators who created the searched content.

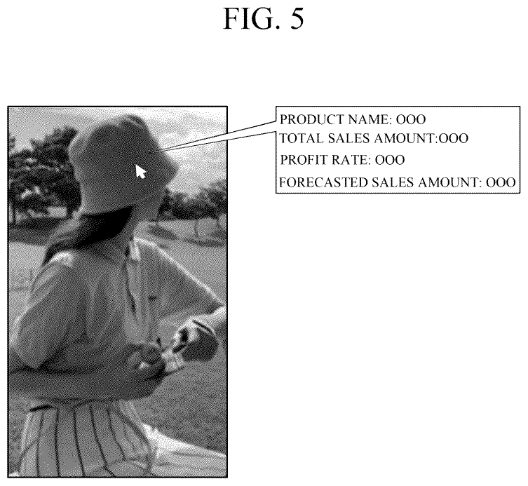

In addition, the platform server 100 can display sales information and sales forecast information for each product included in the content registered on the platform. FIG. 5 is a diagram illustrating a state in which sales-related information of products included in the content is displayed in one embodiment of the present disclosure. In one embodiment, the right of access to the sales-related information of the product included in content may be restricted so that the sales-related information is displayed only to the seller or the supplier.

In one embodiment, when receiving the product promotion request from the supplier terminal 210 or the seller terminal 220, the platform server 100 may extract and display contents related to the corresponding product based on product information included in the product promotion request. In this case, the platform server 100 may extract the contents related to the corresponding product based on the degree of similarity between the product included in the product promotion request and the product included in the already registered content.

Here, when the seller or supplier clicks on a predetermined product in the content registered on the platform, the platform server 100 may display sales-related information of the corresponding product on a screen. Here, the sales-related information of the corresponding product may include total sales amount, sales amount per unit period, profit rate, forecasted sales amount over a certain period of time in the future, and expected profit rate. The seller or supplier may check the sales-related information of the product and select the contents creator who created the corresponding content as the contents creator for promoting his or her product. In this case, the method of contacting the contents creator may be performed in the method illustrated shown in FIG. 4, but is not limited thereto.

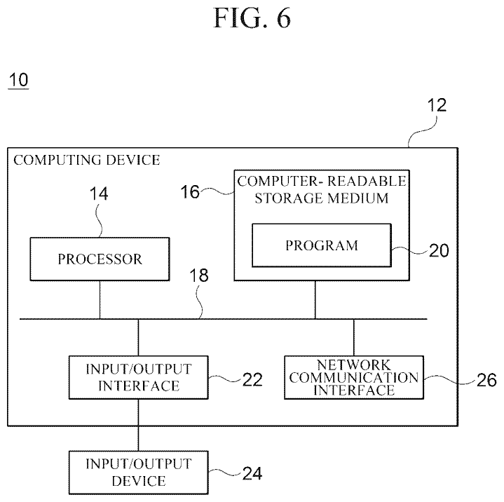

FIG. 6 is a block diagram for illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In one embodiment, the computing device 12 may be the platform server 100. Additionally, computing device 12 may be the supplier terminal 210. Additionally, the computing device 12 may be the seller terminal 220. Additionally, the computing device 12 may be the contents creator terminal 230. Additionally, the computing device 12 may be the purchaser terminal 240.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, the first contents creator and the second contents creator related to the product can be collectively recommended in response to the product promotion request, thereby making it possible to create promotional content quickly, show high level of completion, and increase promotional effectiveness.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

What is claimed is:

1. A method for selecting a contents creator based on e-commerce performed on a computing device including one or more processors and a memory that stores one or more programs executed by the one or more processors, the method comprising:
receiving a product promotion request including product information for a product to be promoted and requester identification information; and
selecting a contents creator to create promotional content for the product in response to the product promotion request, the selecting of the contents creator comprising:
extracting contents including a product related to the product from among contents registered on a platform in an e-commerce environment;
displaying sales-related information including sales information and sales forecast information for a product included in the extracted content; and
displaying information on the contents creator who created the extracted content, the information on the contents creator including information on a first contents creator who is a model for the corresponding product and a second contents creator who created the content and is an expert in each field of the content, the displaying of the information on the contents creator further comprising displaying a button for contacting the contents creator,
wherein the button is linked to an email address of the contents creator or is linked to a mobile phone of the contents creator,
a right of access to the sales-related information is restricted so that the sales-related information is displayed only to a seller or supplier of the corresponding product, and
in the displaying of the sales-related information, when the seller or supplier clicks on a predetermined product in the content registered on the platform, the sales-related information of the clicked product is displayed on a screen.

2. The method of claim 1, wherein the selecting of the contents creator includes:
extracting a first promotional candidate group based on the product information from among first contents creators who have registered content on the platform in the e-commerce environment;
calculating a first promotional suitability level for the product for the first contents creators extracted as the first promotional candidate group; and
finally selecting a first contents creator who serves as a model for product promotion from among the extracted first contents creators according to the calculated first promotional suitability level.

3. The method of claim 2, wherein the extracting of the first promotional candidate group includes:
calculating a degree of similarity between the product included in the product promotion request and the product included in the already registered contents; and
when the calculated similarity is greater than or equal to a preset threshold value, extracting the first contents creator who registered the corresponding content as the first promotional candidate group.

4. The method of claim 2, wherein, in the calculating of the first promotional suitability level, based on suitability level determination factors including one or more of the number of times or frequency of uploads of content related to the product, a degree of social feedback of content related to the product, a degree of influence of the extracted first contents creator, and forecasted sales related to the product of the extracted first contents creator, the first promotional suitability level is calculated for each of the extracted first contents creators.

5. The method of claim 4, wherein the calculating of the first promotional suitability level comprises:
assigning a first-first suitability level score to each of the extracted first contents creators according to one or more of the number of times and frequency of uploads of content related to the product;
assigning a first-second suitability level score to each of the extracted first contents creators according to the degree of social feedback of content related to the product;
assigning a first-third suitability level score according to the influence of each of the extracted first contents creators;
assigning a first-fourth suitability level score according to forecasted sales related to the product of the extracted first contents creators; and
calculating the first promotional suitability level for each of the extracted first contents creators by adding up the first-first suitability level score, the first-second suitability level score, the first-third suitability level score, and the first-fourth suitability level score.

6. The method of claim 5, wherein, in the finally selecting of the first contents creator, the first contents creator with the highest first promotional suitability level among the extracted first contents creators is finally selected as the first contents creator who serves as a model for the product promotion.

7. The method of claim 2, further comprising:
selecting a second contents creator to create promotional content for the product together with the first contents creator finally selected as a model for the product promotion in each field.

8. The method of claim 7, wherein the selecting of the second contents creator in each field includes:
extracting second contents creators who have collaborated with the finally selected first contents creator as a second promotional candidate group in each field;
calculating a second promotional suitability level related to creation of the promotional content for each of the second contents creators extracted as the second promotional candidate group; and
finally selecting a second contents creator in each field from among the extracted second contents creators according to the calculated second promotional suitability level.

9. The method of claim 8, wherein, in the calculating of the second promotional suitability level, the second promotional suitability level is calculated for each of the extracted second contents creators based on suitability level determination factors including one or more of the number of times of collaborations with the finally selected first contents creator, the collaboration satisfaction level of the finally selected first contents creator, and the number of times of content creations related to the product.

10. The method of claim 9, wherein the calculating of the second promotional suitability level comprises:
assigning a second-first suitability level score to each of the extracted second contents creators according to the number of times of collaborations with the finally selected first contents creator;
assigning a second-second suitability level score to each of the extracted second contents creators according to the collaboration satisfaction level of the finally selected first contents creator;
assigning a second-third suitability level score to each of the extracted second contents creators according to the number of times of content creations related to the product; and
calculating the second promotional suitability level by adding up the second-first suitability level score, the second-second suitability level score, and the second-third suitability level score of each of the second contents creators in each field.

11. The method of claim 10, wherein, in the finally selecting of the second contents creator, the second contents creator with the highest second promotional suitability level among the extracted second contents creators is finally selected as the second contents creator to create the promotional content.

12. The method of claim 11, further comprising:
transmitting information on the finally selected first contents creator and the finally selected second contents creator in each field in response to the product promotion request.

13. A computing device comprising:
one or more processors; a memory; and
one or more programs stored in the memory and configured to be executed by the one or more processors, the one or more programs including:
an instruction for receiving a product promotion request including product information for a product to be promoted and requester identification information;
an instruction for selecting a contents creator to create promotional content for the product in response to the product promotion request, the instruction for the selecting of the contents creator including:
an instruction for extracting contents including a product related to the product from among contents registered on a platform in an e-commerce environment;
an instruction for displaying sales-related information including sales information and sales forecast information for a product included in the extracted content; and
an instruction for displaying information on the contents creator who created the extracted content, the information on the contents creator including information on a first contents creator who is a model for the corresponding product and a second contents creator who created the content and is an expert in each field of the content, the instruction for displaying of the information on the contents creator further including displaying a button for contacting the contents creator,
wherein the button is linked to an email address of the contents creator or is linked to a mobile phone of the contents creator,
a right of access to the sales-related information is restricted so that the sales-related information is displayed only to a seller or supplier of the corresponding product, and
in the instruction for displaying of the sales-related information, when the seller or supplier clicks on a predetermined product in the content registered on the platform, the sales-related information of the clicked product is displayed on the screen.
